(19) United States
(12) Patent Application Publication
(10) Pub. No.: US 2024/0014475 A1
(43) Pub. Date: Jan. 11, 2024

(54) BATTERY CELL

(71) Applicant: Rivian IP Holdings, LLC, Irvine, CA (US)

(72) Inventors: Ki Woon Kim, Milpitas, CA (US); Yunki Baik, San Jose, CA (US); Sun Kim, Camas, WA (US)

(21) Appl. No.: 17/858,192

(22) Filed: Jul. 6, 2022

(51) Int. Cl. H01M 50/124; H01M 50/102; H01M 50/178; H01M 50/147

(52) U.S. Cl. CPC H01M 50/1243; H01M 50/102; H01M 50/178; H01M 50/147

(57) ABSTRACT

Disclosed are systems and methods for a device. The device can include a battery housing comprising a first lateral wall and a second lateral wall. The device can include an insulator disposed within the battery housing between the battery housing and an active battery component. A portion of the insulator can be fixed to an inner surface of the first lateral wall and the portion of the insulator fixed to an inner surface of the second lateral wall.

### INTRODUCTION

A vehicle, such as an electric vehicle, can include a battery. The battery can power components of the vehicle.

### SUMMARY

This technical solution is directed to a battery cell having an insulator, such as a pouch insulator. The insulator that insulates active components of a battery cell from a housing of the battery cell. The insulator can be inserted into the housing of the battery cell through an opening of the housing. The insulator can be fixed to the housing around a top portion of the housing. The insulator can include a flexible material (such as polymeric material or plastic). The flexible material can flex when an active battery component is inserted into the insulator, e.g., the insulator can expand or contract around the active battery component within the housing. The insulator can provide a layer of insulation between the active battery components and the housing reducing or eliminating the possibility of the active battery component and the housing coming into contact. In some examples, because the active battery components are not wrapped in an insulating tape or the pouch is not directly connected to the active battery component, when an electrolyte solution is added to the battery cell (e.g., poured or injected into the battery cell and into the pouch), the active battery component can absorb the electrolyte solution. This can improve the ability of the battery to charge, discharge, or store energy. The pouch can be attached to a top portion of the housing leaving a portion from the opening of the housing to the top of the pouch exposed (e.g., bare or uninsulated). This exposed portion can be used for connecting a cover to the housing. The insulator can provide dielectric advantages relative to a battery that does not have this insulator. For example, there can be an air gap between the insulator and the housing. This air gap can provide additional insulation between the active battery component and the housing which enhances the insulating properties of the insulator. Furthermore, the insulator can be a seamless pouch. The seamless pouch may not include any seams and can be a single piece of material. The seamless pouch may reduce or eliminate the likelihood of the pouch leaking the electrolyte solution into the housing of the battery.

At least one aspect is directed to a device. The device can include a battery housing including a first lateral wall and a second lateral wall. The device can include an insulator disposed within the battery housing between the battery housing and an active battery component. A portion of the insulator can be fixed to an inner surface of the first lateral wall and the portion of the insulator fixed to an inner surface of the second lateral wall.

At least one aspect is directed to a method. The method can include providing a battery housing including a first lateral wall and a second lateral wall. The method can include inserting an insulator into the battery housing. The method can include fixing a portion of the insulator to an inner surface of the first lateral wall and to an inner surface of the second lateral wall.

At least one aspect is directed to an electric vehicle. The electric vehicle can include a battery cell. The battery cell can include a battery housing including a first lateral wall and a second lateral wall. The battery cell can include an insulator disposed within the battery housing between the battery housing and an active battery component. A portion of the insulator can be fixed to an inner surface of the first lateral wall and the portion of the insulator fixed to an inner surface of the second lateral wall. The electric vehicle can include a tractive component that transports the electric vehicle based on power received from the battery cell.

At least one aspect is directed to a battery cell. The battery call can include a battery housing including a first lateral wall and a second lateral wall. The battery cell can include an insulator disposed within the battery housing between the battery housing and an active battery component. A portion of the insulator can be fixed to an inner surface of the first lateral wall and the portion of the insulator fixed to an inner surface of the second lateral wall.

At least one aspect is directed to a method. The method can include providing a battery cell. The battery cell can include a battery housing comprising a first lateral wall and a second lateral wall. The battery cell can include an insulator disposed within the battery housing between the battery housing and an active battery component. A portion of the insulator can be fixed to an inner surface of the first lateral wall and the portion of the insulator fixed to an inner surface of the second lateral wall.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example battery cell including an insulator.

FIG. 2 depicts an example prismatic cell including an insulator.

FIG. 3 depicts an example prismatic cell including an insulator and active battery components.

FIG. 4 depicts an example prismatic cell in an exploded view including an insulator

FIG. 5 depicts an example pouch cell including an insulator.

FIG. 6A depicts an example cylindrical cell.

FIG. 6B depicts an example battery cell including multiple pouches.

FIG. 6C depicts an example prismatic battery cell including multiple pouches.

FIG. 7 depicts an example electric vehicle.

FIG. 8 depicts an example method of manufacturing a battery cell including an insulator.

FIG. 9 depicts an example method of providing a battery cell.

### DETAILED DESCRIPTION

Following below are more detailed descriptions of various concepts related to, and implementations of, methods, apparatuses, and systems of a battery insulator. The various concepts introduced above and discussed in greater detail below may be implemented in any of numerous ways.

This disclosure is generally directed to a battery cell including an insulator such as a pouch insulator. A battery cell of an electric vehicle can store energy that is discharged to provide power to components of the electric vehicle, e.g., motors, electronics, lights, computer systems, autonomous or semi-autonomous driving systems. The battery cells can be or include prismatic battery cells, cylindrical cells, pouch cells, or any other form factor battery cell. The battery cells can include a housing such as an outer housing. The outer housing can be an enclosure, a can, a case, pouch, or a container. The housing can include an electrically conductive material such as aluminum. The housing can include an opening through which active components of the battery cell are inserted, e.g., a battery stack, a jelly roll, at least one positive electrode, at least one negative electrode, separators or electrolyte layers between electrodes, or an electrolyte solution.

A cover (e.g., a cap or lid) can be attached across the opening of the battery cell. For example, a cover could be welded (e.g., laser welded) to the top of the battery cell. The housing can be electrically connected to an electrode (e.g., via a current collector) of the active battery component (e.g., anode or cathode) and thus have a polarity of the battery, e.g., a positive polarity or a negative polarity. The housing can be in electrical contact with a positive or negative terminal of the battery cell. A stack of electrodes included within the housing can be electrically isolated from the housing to prevent the electrodes from coming into contact with the housing and shorting.

To prevent the active battery components from contacting or touching the housing, the active battery components can be wrapped in a tape or film that insulates the active battery components from the housing. However, the tape or film insulation may not completely cover the active battery components or housing and shorting can still occur. Furthermore, a tape or film that is wrapped around an active battery component can prevent an electrolyte solution from wetting or soaking into the active battery component (e.g., soaking into a stack or roll of electrodes or separator layers). This can reduce the ability of the battery to charge, discharge, or store energy.

To solve these and other technical problems, the technical solution described herein can include an insulator that insulates an active battery component of a battery cell from a housing of the battery cell. The insulator can be a pouch shaped insulator, a bag shaped insulator, a rectangular solid shaped insulator, a cylindrical shaped insulator, a diamond shaped insulator, a pyramid shaped insulator, or any other form factor. The form factor of the insulator can conform to a form factor of the battery housing. The insulator can be inserted into the housing of the battery cell through an opening of the housing. The insulator can be fixed to the housing around a top portion of the housing. The insulator can include a flexible material (such as a polymeric material or plastic). The flexible material can flex when an active battery component is inserted into the insulator, e.g., the insulator can expand or contract around the active battery component within the housing. The flexible material can include at least one polymer. The polymer can be compatible, and non-reacting, with an electrolyte solution or material of the battery cell. For example, the polymer can be polyethylene, polypropylene, polyimide, or any combination thereof. The insulator can provide a layer of insulation between the active battery component and the housing reducing or eliminating the possibility of the active battery component and the housing shorting. In some examples, because the pouch is not wrapped or otherwise directly connected to the active battery component, when an electrolyte solution is added to the battery cell (e.g., injected or poured into the battery cell and into the pouch), the active battery component can absorb the electrolyte solution. This can improve the ability of the battery to charge, discharge, or store energy.

The pouch can be attached to a top portion of the housing leaving a portion from the opening of the housing to the top of the pouch exposed (e.g., bare or uninsulated). This exposed portion can be used for connecting the cover to the housing. For example, this exposed portion can be used during welding (e.g., laser welding). The length of the exposed portion can be on the order of millimeters. For example, the length can be 1-2 millimeters, 1-5 millimeters, more than 5 millimeter, or less than 1 millimeter. The insulator can be attached to the housing with an adhesive. For example, an adhesive can be applied to a top portion of the insulator and a top portion of the housing causing a top portion of the pouch to adhere to the housing. The rest of the pouch that is not adhered to the housing to flex (e.g., expand or contract when an active battery component is inserted into the insulator).

The insulator can provide further dielectric advantages relative to a battery that does not have this insulator. For example, there can be an air gap between the insulator and the housing. This air gap can provide additional insulation between the active battery component and the housing which enhances the insulating properties of the insulator. The insulator can provide a primary insulation and the air gap can provide an optional or secondary insulation. Furthermore, the insulator can be a seamless pouch. The seamless pouch may not include any seams and can be a single piece of material. For example, the seamless pouch can be formed through a blown film extrusion process or in a mold to be a single piece of material. The seamless pouch may reduce or eliminate the likelihood of the pouch leaking the electrolyte solution into the housing of the battery.

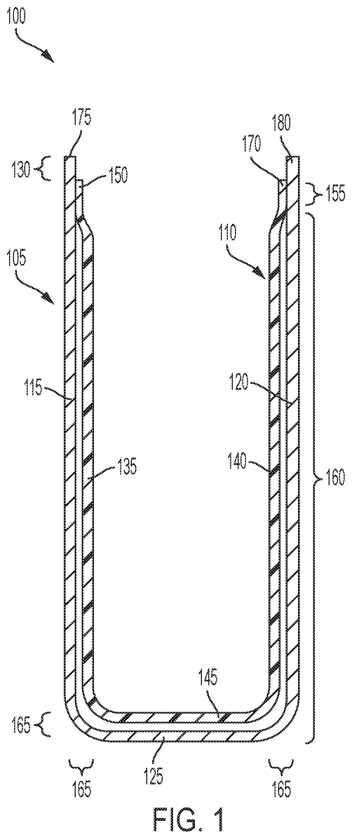

FIG. 1 depicts an example battery cell 100 including at least one insulator 110. The battery cell 100 can be a device that charges via a power source, stores energy, and discharges based on the stored energy to provide power to a consuming device (e.g., a motor of a vehicle, a starter of the vehicle, a data processing system of the vehicle, a light of the vehicle, a sound system of the vehicle). The battery cell 100 can be included within an electric vehicle, a hybrid vehicle, a gas powered vehicle, a diesel powered vehicle, a hydrogen powered vehicle. The battery cell 100 can be disposed in battery modules, battery packs, or battery packs to power components of an electric vehicle. The battery cell 100 can be a lithium-ion battery, nickel-metal hydride battery, a lead-acid battery, or any other type of battery cell.

The battery cell 100 can include at least one battery housing 105. The battery cell 100 or the battery housing 105 can have a variety of form factors, shapes, or sizes. The battery cell 100 or the battery housing 105 can be shaped in a variety of form factors, shapes, or sizes. The battery cell 100 or the battery housing 105 be shaped as a prism (e.g., a prismatic cell), a pouch (e.g., a pouch cell), a cylinder (e.g., a cylindrical cell), a pyramid, a cube, a sphere, a flat low profile shape, or any other form factor. The shape of the battery housing 105 can be prismatic with a polygonal base, such as a triangle, a square, a rectangle, a pentagon, and a hexagon, among others. The battery housing 105 can have a circular, oval, or elliptical shape. The battery housing 105 can completely or partially contain the insulator 110 or at least one active component of the battery cell 100 (e.g., a jelly roll, a battery stack, electrodes, electrode stack, stacked battery layers, wound battery layers, insulating layers, electrolyte solution, separator layers, electrolyte layers). The battery cell 100 can be assembled, for example, by inserting a wound or stacked electrode assembly (e.g., a jelly roll) including electrolyte material into the battery housing 105. The electrolyte material, e.g., an ionically conductive fluid or other material, can generate or provide electric power for the battery cell 100. A first portion of the electrolyte material can have a first polarity, and a second portion of the electrolyte material can have a second polarity. The battery housing 105 can be an outer housing of the battery cell 100. The outer housing can cover or enclose an inner housing or active battery components of the battery cell 100. The battery housing 105 can include a housing within housing form factor, e.g., pouch within pouch, cylindrical enclosure within cylindrical enclosure, prismatic enclosure within prismatic enclosure. The battery housing can be a polarity that connects to other battery cells (e.g., adjacent battery cells in a battery pack).

The battery housing 105 of the battery cell 100 can include one or more materials with various electrical conductivity or thermal conductivity. The electrically conductive and thermally conductive material for the battery housing 105 of the battery cell 100 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the battery housing 105 of the battery cell 100 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others.

The battery housing 105 can include at least one wall. The wall can be flat or curved (e.g., concave or convex). The battery housing 105 can include a first lateral wall 115 and a second lateral wall 120. Although not shown in FIG. 1, the battery housing 105 can include more than two lateral walls, e.g., a third lateral wall and a fourth lateral wall. The first lateral wall 115 and the second lateral wall 120 can extend from a bottom side 125 of the battery cell 100. The first lateral wall 115 can extend up from the bottom side 125 to an end 175 of the first lateral wall 115. The second lateral wall 120 can extend up from the bottom side 125 to an end 180 of the second lateral wall 120. The first lateral wall 115 and the second lateral wall 120 can be parallel to each other. The first lateral wall 115 and the second lateral wall 120 can be located opposite each other. The first lateral wall 115 and the second lateral wall 120 can be oblique to each other. For example, the first lateral wall 115 and the second lateral wall 120 can extend up from the bottom side 125 towards each other. The first lateral wall 115 and the second lateral wall 120 can extend up from the bottom side 125 away from each other. The first lateral wall 115 and the second lateral wall 120 can form angles on an interior side of the battery cell 100 (or on an exterior side of the battery cell 100) with the bottom side 125 of 90 degrees, 80-100 degrees, less than 80 degrees, or more than 100 degrees.

The insulator 110 can be disposed within the battery housing 105. The insulator 110 can provide insulation between an active battery component and an inner surface of the first lateral wall 115, the second lateral wall 120, or the bottom side 125. At least a portion of the insulator 110 can be fixed to at least a portion of at least one inner surface of the battery housing 105. For example, the insulator 110 can be fixed to a portion 155 of the first lateral wall 115 or the second lateral wall 120. Although not shown in FIG. 1, at least a portion of the insulator 110 can be fixed to an inner surface of a third lateral wall or a fourth lateral wall of the battery housing 105. At least a portion of the insulator 110 can be fixed to the bottom side 125. The insulator 110 can prevent an active battery component such as an electrode or electrode stack (e.g., anode, cathode and separator or electrolyte therebetween) from contacting or touching the inner surface of the battery cell 100. The inner surface of the battery cell 100 can be electrically charged to a polarity, e.g., positive or negative. The insulator 110 can be disposed between the battery housing 105 and the active battery component. The insulator 110 can be disposed between an inner surface of the first lateral wall 115, the second lateral wall 120, or the bottom side 125 and the active battery component.

A portion 155 of the insulator 110 can be fixed to an inner surface of the battery cell 100. For example, the portion 155 of the insulator 110 can be fixed to an inner surface of the first lateral wall 115 or the second lateral wall 120. The portion 155 can be 10% of a length of the insulator 110, 20% of a length of the insulator 110, 40% of a length of the insulator, less than 10% of a length of the insulator, more than 40% of a length of the insulator. The portion 155 can be a top portion of the insulator 110. The portion 155 of the insulator 110 can be fixed to the inner surface of the battery housing 105 via an adhesive. The adhesive can be applied in a strip across the inner surface of the battery housing 105. The adhesive can be applied in a continuous line, in a dashed pattern, in a dotted pattern, in a dot-dash pattern, in a horizontal pattern, in a vertical pattern, in a zig-zag pattern. The adhesive can be a material that is compatible with an electrolyte material or solution of the battery cell 100. For example, the adhesive can be a material that does not react (or has a negligible reaction) when the adhesive comes into contact with the electrolyte. The adhesive can be an acrylic, an epoxy, a silicone, an ultraviolet curing epoxy, cyanoacrylate. The adhesive can be applied to at least one wall of the battery housing 105. The adhesive can be applied to at least one wall of the battery housing 105 but not another wall of the battery housing 105. The adhesive can be applied to an inner surface of the first lateral wall 115, the second lateral wall 120, a third lateral wall of the battery housing 105, a fourth lateral wall of the battery housing 105, or the bottom side 125.

An inner surface of the first lateral wall 115 can include a portion 155 that includes adhesive. A portion 160 of the inner surface the first lateral wall 115 can be free of adhesive. For example, the portion 160 of the inner surface of the first lateral wall 115 may not include any adhesive. An inner surface of the second lateral wall 120 can include a portion 155 that includes adhesive. A portion 160 of the inner surface of the second lateral wall 120 can be free of adhesive. For example, the portion 160 of the inner surface of the second lateral wall 120 may not include any adhesive. At least a portion of an inner surface of the bottom side 125 can include adhesive. The inner surface of the bottom side 125 can also be free of adhesive. For example, the bottom side 125 may not include any adhesive. A portion of an inner surface of a third or fourth lateral wall of the battery housing 105 can include adhesive. Another portion of the inner surface of the third or fourth lateral wall of the battery housing 105 can be free of adhesive.

The end 150 of a first lateral side 135 of the insulator 110 can be fixed to an inner surface of the first lateral wall 115 a distance from an end 175 of the first lateral wall 115. The distance can define an exposed portion 130 of the inner surface of the first lateral wall 115. The distance can be 2-3 millimeters, 1-5 millimeters, less than 1 millimeter, or more than 5 millimeters. The end 170 of a second lateral side 140 of the insulator 110 can be fixed to an inner surface of the second lateral wall 120 a distance from an end 180 of the second lateral wall 120. The distance can define an exposed portion 130 of the inner surface of the second lateral wall 120. The distance can be 2-3 millimeters, 1-5 millimeters, less than 1 millimeter, or more than 5 millimeter. An exposed portion 130 may or may not exist for a third lateral wall of the battery housing 105 or a fourth lateral wall of the battery housing 105. The exposed portion 130 of battery housing 105 can be provided for a cover (e.g., cap, lid, top portion) to be fixed to the exposed portion 130. For example, the cover can be electrically connected to the exposed portion 130. The cover can be fixed to the exposed portion 130 via welding (e.g., laser welding). The cover can be fixed to the exposed portion 130 via an adhesive, glue, rivets, bolts, screws, solder.

The bottom side 145 of the insulator can be fixed to an inner surface of the bottom side 125 of the battery housing 105 via an adhesive. The bottom side 145 may be free of adhesive. The bottom side 145 can rest upon the inner surface of the bottom side 125 or be suspended over the inner surface of the bottom side 125. The first lateral side 135 can be fixed to the inner surface of the first lateral wall 115 via an adhesive. A portion 155 of the first lateral side 135 can be fixed via the adhesive. A portion 160 of the first lateral side 135 can be free of adhesive. The portion 160 of the first lateral side 135 can rest upon or be free from the inner surface of the first lateral wall 115. The second lateral side 140 can be fixed to the inner surface of the second lateral wall 120 via an adhesive. A portion 155 of the second lateral side 140 can be fixed via the adhesive. A portion 160 of the second lateral side 140 can be free of adhesive. The portion 160 of the second lateral side 140 can rest upon or be free from the inner surface of the second lateral wall 120.

The insulator 110 can be a pouch, a bag, a prismatic shape, a spherical shape, a cylindrical shape, a pyramid shape, or any other form factor. The insulator 110 can include at least one side. The insulator 110 can include a first lateral side 135 and a second lateral side 140. The first lateral side 135 and the second lateral side 140 can extend from a bottom side 145 of the insulator 110 to an opening of the insulator 110. The first lateral side 135 can extend from the bottom side 145 to an end 150 of the first lateral side 135. The second lateral side 140 can extend from the bottom side 145 to an end 170 of the second lateral side 140. The first lateral side 135 and the second lateral side 140 can meet at a bottom end opposite the opening of the insulator 110. For example, the bottom side 145 may not be included and the first lateral side 135 and the second lateral side 140 can meet in a curved manner.

The insulator 110 can be a seamless pouch. The seamless pouch may not include any seams and can be a single piece of material. For example, the seamless pouch can be formed through a blown film extrusion process or in a mold to be a single piece of material. The seamless pouch can be flexible and take on a shape of an interior of the battery housing 105. The insulator 110 can expand (e.g., stretch) or contract responsive to an insertion of an active battery component into the battery housing 105 and into the insulator 110. The insulator 110 can take on the shape of an active battery component (e.g., battery stack or battery roll) inserted into the insulator 110. Furthermore, the insulator can take on the shape of a battery stack or battery roll wetted by liquid electrolyte. During an electrolyte fill process where an electrolyte fluid is injected into the insulator 110, the insulator 110 can expand to hold the electrolyte fluid or a wetted electrode stack wetted with the electrolyte fluid. The insulator 110 can be a polymeric or plastic material. The polymer can be compatible, and non-reacting, with an electrolyte solution or material of the battery cell. For example, the polymer can be polyethylene, polypropylene, polyimide, or any combination thereof. In another example, the insulator can include polymer blends and/or multiple layers of different polymeric materials having properties selected for electrolyte stability, mechanical stability, cost and/or the like.

The insulator 110 and the battery housing 105 can define at least one gap such as an air gap 165. The air gap 165 can include air or other gas or fluid to provide an insulation between the battery housing 105 and an active battery component disposed within the insulator 110. The air gap 165 can be a 2-3 millimeter gap, 1-5 millimeter gap, a gap greater than 5 millimeters, or a gap less than 1 millimeter. The air gap 165 can have a non-uniform thickness. For example the air gap 165 along the first lateral wall 115 can be greater than the air gap along the second lateral wall 120. The air gap 165 can also vary in length or thickness along one lateral wall (e.g., first lateral wall 115 or second lateral wall 120.) At least some portions of the insulator 110 can also touch or contact the inner surface of the first lateral wall 115 or the second lateral wall 120. In these areas of contact there can be no air gap 165.

The insulator 110 can be a material strong enough to withstand any pressure that builds up in the air gap 165 when an active battery component is inserted into the insulator 110. The insulator 110 can include one or more pressure release holes at a top portion of the insulator 110 to release air from the air gap 165 when the active battery component is inserted into the insulator 110 and/or when liquid electrolyte is injected into the insulator during an electrolyte filling or formation process. When the liquid electrolyte is injected into the battery cell 110, the liquid electrolyte can diffuse and partially or complete wet pores of electrodes and separators between the electrodes disposed within the insulator 110. This can cause the electrodes or separators to expand. The insulator 110 can expand to hold the electrodes or separators. The wetting or diffusion of the liquid electrolyte in the separators can form electrolyte layers. One or more lateral sides of the battery housing 105 can include adhesive while one or more other lateral sides of the battery housing 105 may not include adhesive. The insulator 110 can be fixed to the one or more lateral sides via the adhesive.

When the active component of the battery is inserted into the insulator 110, the pressure of the air gap can be released via an opening formed on the one or more other lateral sides that do not include the adhesive. As such, the final battery cell may not have any air or other gas between the insulator 110 and the battery housing 105. For example, electrodes or separator layers can be inserted into the insulator 110 expanding the insulator and forcing air or gas out of the battery housing 105. Furthermore, an electrolyte can be added to the battery cell after the active battery components are added to the insulator 110 and a cover is fixed across the battery housing 105. The cover can be sealed to the battery housing 105. A hole in the cover can be used to insert an electrolyte fluid into the battery housing 105 and the insulator 110. The electrolyte fluid can expand the insulator 110. This can push the insulator 110 against an inner surface of the battery housing 105. The electrolyte fluid can wet or soak into the active battery components disposed within the insulator 110. This can cause the air or gas between the insulator 110 and the battery housing 105 to partially or completely escape. The battery cell 100 can be filled with an electrolyte fluid through applying negative pressure to an assembled and unsealed battery cell 100. The insulator 110 can flex to expand and hold the electrolyte liquid or electrodes or separator layers wetted with the electrolyte liquid.

The adhesive can be applied in a dotted or dashed manner in a strip around at least one side of the inner surface of the battery housing 105. When the active battery component is inserted into the insulator 110, the pressure may be released through openings between the adhesive dots or dashes. The pressure of the active battery component on the inner surface of the battery housing 105 can cause the dots or dashes to spread-out forming a line of adhesive. In this regard, the pressure can be released from the air gap 165 and a seal can be formed via the adhesive.

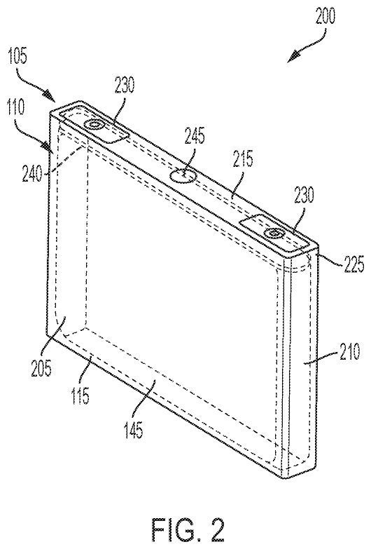

FIG. 2 depicts an example battery cell 100, such as a prismatic battery cell that includes the insulator 110. The insulator 110 can include a third lateral side 205 and a fourth lateral side 210. The first lateral side 135, the second lateral side 140, the third lateral side 205, and the fourth lateral side 210 can extend up from the bottom side 145 and define an opening of the insulator 110. Active battery components such as electrodes, separators, insulators, and/or an electrolyte solution or material can be inserted into the insulator 110 through the opening. An adhesive strip 240 can go around at least a portion of the opening of the insulator 110 fixing at least one of the first lateral side 135, the second lateral side 140, the third lateral side 205, and the fourth lateral side 210 to the lateral walls of the battery housing 105.

The adhesive strip 240 can be applied to an outer surface of the insulator 110, e.g., across at least one of the sides of the insulator 110. When the insulator 110 is inserted into the battery housing 105, the insulator 110 can be pressed against the inner surface of the battery housing 105. When the adhesive cures, the insulator 110 can be fixed to the inner surface of the battery housing 105. The adhesive strip 240 can be applied to an inner surface of the battery housing 105. When the insulator 110 is inserted into the battery housing 105, the insulator can be pressed against the inner surface of the battery housing 105 and the adhesive strip 240. When the adhesive cures, the insulator 110 can be fixed to the inner surface of the battery housing 105.

The prismatic battery cell 100 includes a cover 215. The cover 215 can cover an opening of the battery housing 105. The cover 215 can be fixed to the battery housing 105. For example, the cover 215 can be fixed to the battery housing 105 via welding (e.g., laser welding), soldering, an adhesive, a rivet, a pin, a button, a bolt, a fastener, a hook, a latch, a screw. The cover 215 can be electrically coupled with the walls or the bottom of the battery housing 105. The cover 215 include terminals 230. One terminal 230 can be electrically coupled to the cover 215 or a side, or a bottom of the battery housing 105. The terminals 230 can be electrically coupled to electrodes included within the battery housing 105 and within the insulator 110. The terminals 230 can include anode or cathode terminals. The battery housing 105 of the prismatic battery cell 100 can include a fourth lateral wall 225. The cover 215 can be connected to the fourth lateral wall 225. The fourth lateral wall 225 can extend from a bottom side 125 up to an end of the fourth lateral wall 225. Adhesive can be applied to the fourth lateral wall 225 to fix the fourth lateral side 210 of the insulator 110 to the fourth lateral wall 225. The battery 100 includes a vent 245. The vent 245 can be located on the cover 215. The vent 245 can release or exhaust gas.

The cover 215 and the battery housing 105 can be electrically coupled. The cover 215 or the battery housing 105 can be electrically coupled to a positive or negative polarity of the battery 100. In some cases, the positive or negative polarity of the battery electrically floated from the cover 215 or the battery housing 105, e.g., the positive or negative polarity or both polarities can be electrically separated from the cover 215 or the battery housing 105. Even though the cover 215 or the battery housing 105 can be electrically separated from the negative or positive electrodes of the battery 100, the insulator 110 can still provide insulation of inner surface of the battery housing 105 to prevent a negative or positive polarity electrode from contacting an inner surface of the battery housing 105. By preventing a negative or positive electrode from contacting an inner surface of the battery housing 105 that could be a LiAl alloy, a LiAl alloy reaction can be avoided preventing any corrosion to the battery housing 105. By using the insulator 110 to insulate the active battery components from the battery housing 105, the positive and negative terminals can be floated from the battery housing 105.

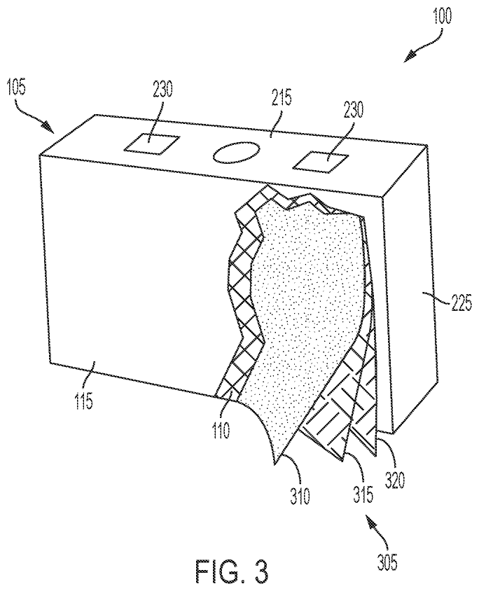

FIG. 3 depicts an example prismatic cell 100 including the insulator 110 at least one active battery component 305. The active battery component 305 can include an electrode stack or an electrode roll. The active battery component 305 can include layers of electrodes 310 and 320 formed in a stack or wound around an axis. The layers of electrodes 310 and 320 can alternate between positive electrodes (cathode layers 310) and negative electrodes (anode layers 320). The positive electrodes can all be electrically coupled. The negative electrodes can all be electrically coupled. The battery housing can be electrically connected with the anode or cathode via the terminals of the terminals 230 or the current collector of the battery cell 100.

Each positive and negative layer can be separated by an electrolyte layer 315 (e.g., a polymeric separator wetted by a liquid electrolyte or a solid state electrolyte). The electrolyte layer 315 can separate the layers of electrodes 310. For example, the electrolyte layer 315 can be a sheet of separator material that can receive (e.g., be wetted by, be saturated with) a liquid electrolyte substance. The liquid electrolyte material can be used in liquid electrolyte batteries, for example. The electrolyte layer 315 can receive the liquid electrolyte material during a filling and/or formation operation associated with assembly of a battery cell. The electrolyte layer 315 can be a sheet of solid electrolyte material. For example, the electrolyte layer 315 can be or include a solid electrolyte material. The solid electrolyte material can be or include a solid-state electrolyte layer that can conduct ions. For example, the electrolyte layer 315 can be or include a solid electrolyte material that can conduct ions without receiving a separate liquid electrolyte sub stance.

The electrolyte layer 315 can include or be made of a liquid electrolyte material. For example, the electrolyte layer 315 can be or include at least one layer of polymeric material (e.g., polypropylene (PP), polyethylene (PE), or other material) that is wetted (e.g., is saturated with, is soaked with, receives) a liquid electrolyte substance. The liquid electrolyte material can include a lithium salt dissolved in a solvent. The lithium salt for the liquid electrolyte material for electrolyte layer 315 can include, for example, lithium tetrafluoroborate (LiBF₄), lithium hexafluorophosphate (LiPF₆), and lithium perchlorate (LiClO₄), among others. The solvent can include, for example, dimethyl carbonate (DMC), ethylene carbonate (EC), and diethyl carbonate (DEC), among others. The electrolyte layer 315 can include or be made of a solid electrolyte material, such as a ceramic electrolyte material, polymer electrolyte material, or a glassy electrolyte material, or among others, or any combination thereof. The ceramic electrolyte material for electrolyte layer 315 can include, for example, lithium phosphorous oxy-nitride (LiₓPO_{y}N_{z}), lithium germanium phosphate sulfur (Li₁₀GeP₂S₁₂), Yttria-stabilized Zirconia (YSZ), NASICON (Na₃Zr₂Si₂PO₁₂), beta-alumina solid electrolyte (BASE), perovskite ceramics (e.g., strontium titanate (SrTiO₃)), among others. The polymer electrolyte material (e.g., a hybrid or pseudo-solid state electrolyte) for electrolyte layer 315 can include, for example, polyacrylonitrile (PAN), polyethylene oxide (PEO), polymethyl-methacrylate (PMMA), and polyvinylidene fluoride (PVDF), among others. Whether the electrolyte layer 315 that can receive a liquid electrolyte (e.g., lithium ion batteries) or electrolyte layers that can conduct ions without receiving a liquid electrolyte (e.g., solid-state batteries), the glassy electrolyte material for the electrolyte layer 315 can include, for example, lithium sulfide-phosphor pentasulfide (Li₂S—P₂S₅), lithium sulfide-boron sulfide (Li₂S—B₂S₃), and Tin sulfide-phosphor pentasulfide (SnS—P₂S₅), among others.

In examples where the electrolyte layer 315 includes a liquid electrolyte material, the electrolyte layer 315 can include a non-aqueous polar solvent. The non-aqueous polar solvent can include a carbonate such as ethylene carbonate, propylene carbonate, diethyl carbonate, ethyl methyl carbonate, dimethyl carbonate, or a mixture of any two or more thereof. The electrolyte layer 315 can include at least one additive. The additives can be or include vinylidene carbonate, fluoroethylene carbonate, ethyl propionate, methyl propionate, methyl acetate, ethyl acetate, or a mixture of any two or more thereof. The electrolyte layer 315 can include a lithium salt material. For example, the lithium salt can be lithium perchlorate, lithium hexafluorophosphate, lithium bis(fluorosulfonyl)imide, lithium bis(trifluorosulfonyl)imide, or a mixture of any two or more thereof. The lithium salt may be present in the electrolyte layer 315 from greater than 0 M to about 1.5 M.

The battery cell 100 can include at least one anode layer 320, which can be disposed within a cavity defined by the battery housing 105. The anode layer 320 can receive electrical current into the battery cell 100 and output electrons during the operation of the battery cell 100 (e.g., charging or discharging of the battery cell 100). The anode layer 320 can include an active substance. The active substance can include, for example, an activated carbon or a material infused with conductive materials (e.g., artificial or natural Graphite, or blended), lithium titanate (Li₄Ti₅O₁₂), or a silicon-based material (e.g., silicon metal, oxide, carbide, pre-lithiated).

The battery cell 100 can include at least one cathode layer 310 (e.g., a composite cathode layer compound cathode layer, a compound cathode, a composite cathode, or a cathode). The cathode layer 310 can be disposed within the cavity. The cathode layer 310 can output electrical current out from the battery cell 100 and can receive electrons during the discharging of the battery cell 100. The cathode layer 310 can also release lithium ions during the discharging of the battery cell 100. Conversely, the cathode layer 310 can receive electrical current into the battery cell 100 and can output electrons during the charging of the battery cell 100. The cathode layer 310 can receive lithium ions during the charging of the battery cell 100.

The battery cell 100 can include an electrolyte layer 315 disposed within the cavity. The electrolyte layer 315 can be arranged between the anode layer 320 and the cathode layer 310 to separate the anode layer 320 and the cathode layer 310. The electrolyte layer 315 can transfer ions between the anode layer 320 and the cathode layer 310. The electrolyte layer 315 can transfer cations from the anode layer 320 to the cathode layer 310 during the operation of the battery cell 100. The electrolyte layer 315 can transfer anions (e.g., lithium ions) from the cathode layer 310 to the anode layer 320 during the operation of the battery cell 100.

The electrolyte layer 315 can include or be made of a liquid electrolyte material. The liquid electrolyte material can include a lithium salt dissolved in a solvent. The lithium salt for the liquid electrolyte material for the electrolyte layer 315 can include, for example, lithium tetrafluoroborate (LiBF₄), lithium hexafluorophosphate (LiPF₆), and lithium perchlorate (LiClO₄), among others. The solvent can include, for example, dimethyl carbonate (DMC), ethylene carbonate (EC), and diethyl carbonate (DEC), among others. The electrolyte layer 315 can include or be made of a solid electrolyte material, such as a ceramic electrolyte material, polymer electrolyte material, or a glassy electrolyte material, or among others, or any combination thereof. The ceramic electrolyte material for the electrolyte layer 315 can include, for example, lithium phosphorous oxy-nitride (LiₓPO_{y}N_{z}), lithium germanium phosphate sulfur (Li₁₀GeP₂S₁₂), Yttria-stabilized Zirconia (YSZ), NASICON (Na₃Zr₂Si₂PO₁₂), beta-alumina solid electrolyte (BASE), perovskite ceramics (e.g., strontium titanate (SrTiO₃)), among others. The polymer electrolyte material (e.g., a hybrid or pseudo-solid state electrolyte) for electrolyte layer 315 can include, for example, polyacrylonitrile (PAN), polyethylene oxide (PEO), polymethyl-methacrylate (PMMA), and polyvinylidene fluoride (PVDF), among others. The glassy electrolyte material for the electrolyte layer 315 can include, for example, lithium sulfide-phosphor pentasulfide (Li₂S—P₂S₅), lithium sulfide-boron sulfide (Li₂S—B₂S₃), and Tin sulfide-phosphor pentasulfide (SnS—P₂S₅), among others.

For example, the battery cell 100 can be or include a lithium-ion battery cell. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 100 to separate the anode and cathode from each other and to facilitate transfer of lithium ions between the anode and cathode. It should be noted that battery cell 100 can also take the form of a solid state battery cell developed using solid electrodes and solid electrolytes. Yet further, some battery cells 100 can be solid state battery cells and other battery cells 100 can include liquid electrolytes for lithium-ion battery cells.

The battery cell can include a cathode layer 310. For example, the battery cell 305 can include the cathode layer 310 comprising a cathode material (e.g., a composite cathode layer compound cathode layer, a compound cathode, a composite cathode, or a cathode). The cathode layer 310 can include a first redox potential. The cathode layer 310 can output electrical current out from the battery cell 820 and can receive electrons during the discharging of the battery cell 305. The cathode layer 310 can also release lithium ions during the discharging of the battery cell 305. Conversely, the cathode layer 310 can receive electrical current into the battery cell 305 and can output electrons during the charging of the battery cell 305. The cathode layer 310 can receive lithium ions during the charging of the battery cell 305.

The battery cell 305 can include an anode layer 320. The anode layer 320 can include a second redox potential that can be different from the first redox potential of the cathode layer 310. For example, the anode layer 320 can be an anode material that can receive electrical current into the battery cell 305 and output electrons during the operation of the battery cell 305 (e.g., charging or discharging of the battery cell 305). The anode layer 320 can include an active substance. The active substance can include, for example, an activated carbon or a material infused with conductive materials (e.g., artificial or natural Graphite, or blended), lithium titanate (Li₄Ti₅O₁₂), or a silicon-based material (e.g., silicon metal, oxide, carbide, pre-lithiated). The active substance can include graphitic carbon (e.g., ordered or disordered carbon with sp2 hybridization), Li metal anode, or a silicon-based carbon composite anode. In some examples, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell does not comprise an anode active material in an uncharged state.

The redox potential of layers (e.g., the first redox potential of the cathode layer 310, the second redox potential of the anode layer 320) can vary based on a chemistry of the respective layer or a chemistry of the battery cell. For example, lithium-Ion batteries can include an LFP (lithium iron phosphate) chemistry, an NMC (Nickel Manganese Cobalt) chemistry, an NCA (Nickel Cobalt Aluminum) chemistry, or an LCO (lithium cobalt oxide) chemistry for a cathode layer (e.g., the cathode layer 310, or other layers). Lithium-ion batteries can include a graphite chemistry, a silicon-graphite chemistry, or a lithium metal chemistry for the anode layer (e.g., the anode layer 320). For example, a cathode layer having an LFP chemistry can have a redox potential of 3.45 V, while an anode layer having a graphite chemistry can have a 0.25V redox potential.

Electrode layers can include anode active material or cathode active material, commonly in addition to a conductive carbon material, a binder, other additives as a coating on a current collector (metal foil). The chemical composition of the electrode layers can affect the redox potential of the electrode layers. For example, cathode layers can include high-nickel content (>80% Ni) lithium transition metal oxide, such as a particulate lithium nickel manganese cobalt oxide (“LiNMC”), a lithium nickel cobalt aluminum oxide (“LiNCA”), a lithium nickel manganese cobalt aluminum oxide (“LiNMCA”), or lithium metal phosphates like lithium iron phosphate (“LFP”) and Lithium iron manganese phosphate (“LMFP”). Anode layers can include conductive carbon materials such as graphite, carbon black, carbon nanotubes, and the like. Anode layers can include Super P carbon black material, Ketjen Black, Acetylene Black, SWCNT, MWCNT, graphite, carbon nanofiber, or graphene, for example.

Electrode layers can also include chemical binding materials (e.g., binders). Binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Binder materials can include agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (Plpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

Current collector materials (e.g., a current collector foil to which a battery active material is laminated to form a cathode layer or an anode layer) can include a metal material. For example, current collector materials can include aluminum, copper, nickel, titanium, stainless steel, or carbonaceous materials. The current collector material can be formed as a metal foil. For example, the current collector material can be an aluminum (Al) or copper (Cu) foil. The current collector material can be a metal alloy, made of Al, Cu, Ni, Fe, Ti, or combination thereof. The current collector material can be a metal foil coated with a carbon material, such as carbon-coated aluminum foil, carbon-coated copper foil, or other carbon-coated foil material.

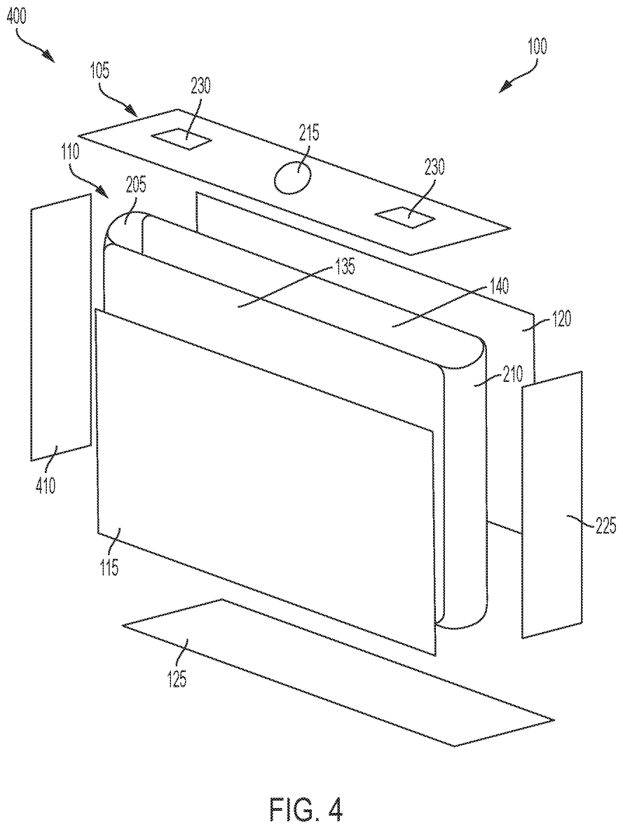

FIG. 4 depicts an example prismatic battery cell 100 in an exploded view of the battery cell 100 including the insulator 110. The exploded view depicts the walls of the prismatic battery cell 100 detached from each other. The battery housing 105 can include at least one bottom side 125. The bottom side 125 can be parallel with the cover 215. The bottom side 125 and the cover 215 can be slightly offset from parallel, e.g., offset by 1-5 degrees, 5-10 degrees, more than 10 degrees, or less than 1 degree. The battery housing 105 can further include a third lateral wall 410. The third lateral wall 410 can extend from the bottom side 125 up to an end of the third lateral wall 410. A top side of the third lateral wall 410 can extend up to the cover 215. The third lateral wall 410 and the fourth lateral wall 225 can be parallel. The third lateral wall 410 and the fourth lateral wall 225 can be slightly offset from parallel, e.g., offset by 1-5 degrees, 5-10 degrees, more than 10 degrees, less than 1 degree. The third lateral side 205 of the insulator 110 can be fixed to the third lateral wall 410. For example, a top portion of the third lateral side 205 can be fixed to a top portion of the third lateral wall 410. For example, adhesive can be applied to the top portion of the third lateral side 205 of the insulator 110 or the top portion of the third lateral wall 410 of the battery housing 105. The adhesive can fix the third lateral side 205 of the insulator 110 to the third lateral wall 410 of the battery housing 105.

The adhesive can be applied across an inner surface of at least one of the first lateral wall 115, the second lateral wall 120, the third lateral wall 410, and the fourth lateral wall 225. The adhesive can be applied to the portion 155 of at least one of the first lateral wall 115, the second lateral wall 120, the third lateral wall 410, and the fourth lateral wall 225. The adhesive can be applied laterally across the inner surfaces of at least one of the first lateral wall 115, the second lateral wall 120, the third lateral wall 410, and the fourth lateral wall 225. An outer surface the first lateral side 135 of the insulator 110 can be fixed to the inner surface of the first lateral wall 115 via the adhesive. An outer surface the second lateral side 140 of the insulator 110 can be fixed to the inner surface of the second lateral wall 120 via the adhesive. An outer surface the third lateral side 205 of the insulator 110 can be fixed to the inner surface of the third lateral wall 410 via the adhesive. An outer surface the fourth lateral side 210 can be fixed to the inner surface of the fourth lateral wall 225 via the adhesive.

The walls of the battery housing 105 can be soldered together, welded (laser welded) together, fixed via adhesive, fixed with rivets, fixed with snaps, fixed screws. The battery housing 105, when the walls are fixed together, can hold solids, liquids, or gasses without allowing any leakage (or without any substantial leakage). For example, an edge of the bottom side 125 can be fixed to an edge of the first lateral wall 115. Another edge of the bottom side 125 can be fixed to an edge of the second lateral wall 120. Another edge of the bottom side 125 can be fixed to an edge of the third lateral wall 410. Another edge of the bottom side 125 can be fixed to an edge of the fourth lateral wall 225. An edge of the first lateral wall 115 can be fixed to an edge of the third lateral wall 410. An edge of the first lateral wall 115 can be fixed to an edge of the fourth lateral wall 225. An edge of the fourth lateral wall 225 can be fixed to an edge of the second lateral wall 120. An edge of the third lateral wall 410 can be fixed to an edge of the second lateral wall 120.

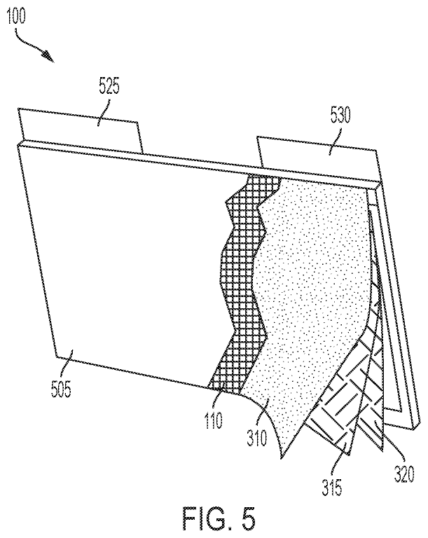

FIG. 5 depicts an example battery cell 100, such as a pouch battery cell. The pouch battery cell 100 can include an enclosure 505 that is pouch shaped. The enclosure 505 can be a plastic, aluminum, or aluminum-plastic film. The enclosure 505 can be flexible. The enclosure 505 may not be a hard or rigid component. An inner or outer surface of the enclosure 505 can be float freely from a positive or negative polarity of the pouch battery cell 100. The enclosure 505 may be electrically coupled to a positive or negative polarity of the pouch battery cell 100. The pouch battery cell 100 can include the insulator 110. Active components of the pouch battery cell 100 can be disposed within the enclosure 505 or the insulator 110. For example, at least one negative electrode layer 310 (anode layer), at least one electrolyte layer 315, and at least one positive electrode layer 320 (cathode layer) can be disposed within the enclosure 505 or the insulator 110. The positive electrode layers 310 can be electrically coupled to a positive tab 525 of the pouch battery cell 100. The negative electrode layers 320 can be electrically coupled to a negative tab 530 of the pouch battery cell 100.

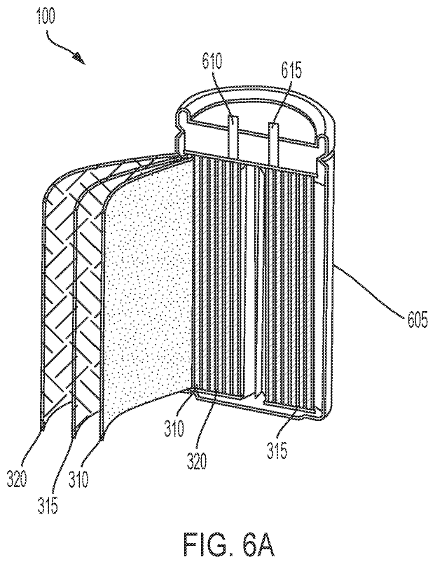

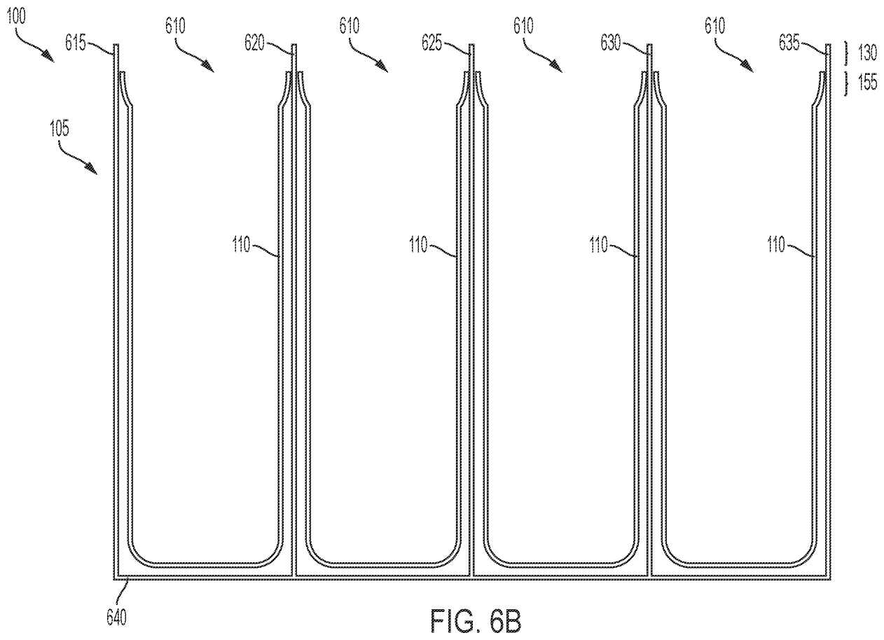

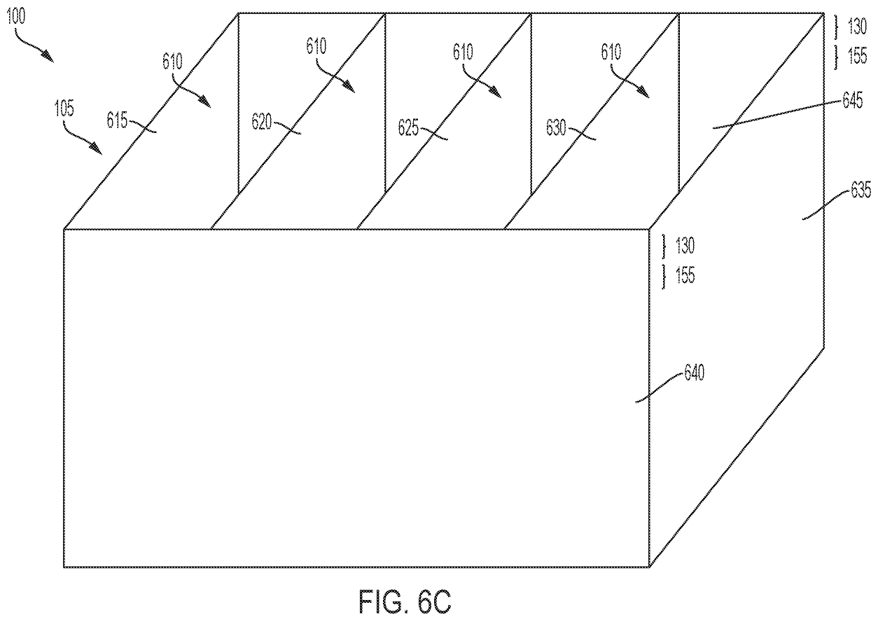

The housing or outer enclosure of the battery cell can be prismatic (e.g., as depicted in FIGS. 3 and 4, among others) or cylindrical (e.g., as depicted in FIG. 6A), the enclosure can include a rigid or semi-rigid material such that the enclosure is rigid or semi-rigid (e.g., not easily deformed or manipulated into another shape or form factor). In examples where the enclosure includes a pouch form factor, (e.g., as depicted in FIG. 5), the enclosure can include a flexible, malleable, or non-rigid material such that the enclosure can be bent, deformed, manipulated into another form factor or shape.

FIG. 6A depicts an example cylindrical battery cell 100. The housing 605 can be cylindrical, for example. The housing 605 can be of any shape, such as cylindrical with a circular (e.g., as depicted), elliptical, or ovular base, among others. The housing 605 can be continuous or circular. Electrical connections can be made between an electrolyte material and components of the battery cell 100. For example, electrical connections with at least some of the electrolyte material can be formed at two points or areas of the battery cell 100, for example to form a first polarity terminal 230 (e.g., a positive or cathode terminal) and a second polarity terminal 230 (e.g., a negative or anode terminal). The polarity terminals can be made from electrically conductive materials to carry electrical current from the battery cell 100 to an electrical load, such as a component or system of an electric vehicle.

The insulator 110 can have an opening that is a circular, elliptical, or ovular shape. The insulator 110 can be a cylindrical shape with a continuous lateral side that forms a circle, ellipse, or oval. The continuous lateral side can extend up from a circular, elliptical, or ovular base up to the opening. An outer surface of a top portion of the continuous lateral side can be fixed to an inner surface of the housing 605. The continuous lateral side can be subdivided into a number of sections each defining a particular curved lateral wall, e.g., a first lateral wall, a second lateral wall, a third lateral wall, a fourth lateral wall, a fifth lateral wall, etc. At least one portion of the continuous lateral wall (or a first side, a second side, a third side, or a fourth side) can be fixed via an adhesive to the inner surface of the housing 605. The housing 605 can be subdivided into a number of sections each defining a particular curved lateral wall, e.g., a first lateral wall, a second lateral wall, a third lateral wall, a fourth lateral wall, a fifth lateral wall, etc. An outer surface of a first lateral wall of the insulator 110 can be fixed to an inner surface of a first lateral wall of the housing 605. An outer surface of a second lateral wall of the insulator 110 can be fixed to an inner surface of a second lateral wall of the housing 605. An outer surface of a third lateral wall of the insulator 110 can be fixed to an inner surface of a third lateral wall of the housing 605. An outer surface of a fourth lateral wall of the insulator 110 can be fixed to an inner surface of a fourth lateral wall of the housing 605.

FIG. 6B depicts an example battery cell 100 including multiple pouches 110. The battery cell 100 can be a prismatic shaped battery cell. The battery cell 100 of FIG. 6B is shown from a side view. The battery cell 100 can include a battery housing 105 that includes multiple chambers 610. The chambers 610 can be arranged in a row within the battery housing 105. The chambers 615 can be arranged in a grid pattern within the battery housing 105, e.g., columns and rows of chambers 610. The chambers 615 can be arranged in a diagonal pattern within the housing 105. The chambers 615 can be arranged in a circular or arced pattern within the housing 105. The chambers 615 can be arranged in a free-form pattern within the battery housing 105. The chambers 615 can be arranged in a variety of patterns within the battery housing 105.

The chambers 610 can be shaped as prisms, pouches, cylinders, pyramids, cubes, spheres, flat low profile shapes, or any other form factor. Each chamber 610 can be the same size or shape. The chambers 610 can be a mix of shapes or sizes. Although four chambers 610 are shown in FIG. 6B, the battery cell 100 can include any number of chambers, e.g., two chambers, three chambers, more than four chambers. A first chamber 610 can be formed by a first lateral wall 615 and a second lateral wall 620 that extend up from a bottom side 640 of the battery housing 105 up to an opening of the first chamber 610. A second chamber 610 can be formed by the second lateral wall 620 and a third lateral wall 625 that extend up from the bottom side 640 of the battery housing 105 to an opening of the second chamber 610. A third chamber 610 can be formed by the third lateral wall 625 and a fourth lateral wall 630 that extend up from the bottom side 640 to an opening of the third chamber 610. A fourth chamber 610 can be formed by the fourth lateral wall 630 and a fifth lateral wall 635 that extend up from the bottom side 640 to an opening of the fourth chamber 610.

The battery housing 105 can include active battery components within at least one chamber 610. The chambers 610 can include at least one anode layer 320, at least one electrolyte layer 315, at least one cathode layer 310, and an electrolyte solution. The battery components of each chamber 610 can be electrically connected to form a single battery. For example, the anode layers 320 of each chamber 610 can be electrically connected and the cathode layers 310 of each chamber 610 can be electrically connected. The battery components of each chamber 610 can form discrete battery cells within each chamber 610. The battery cells of the chambers 610 can be electrically coupled series or in parallel.

At least one chamber 610 can include an insulator 110. Each chamber 610 can include an insulator 110. The insulators 110 can be fixed to a portion 155 of at least one lateral wall that forms each chamber 110. The insulator 110 can be fixed to at least one lateral wall that forms each chamber 110 by an adhesive. A first insulator 110 of a first chamber 610 can be fixed to a portion 155 of at least one of the first lateral wall 615 and the second lateral wall 620. A second insulator 110 of a second chamber 610 can be fixed to a portion 155 of at least one of the second lateral wall 620 and the third lateral wall 625. A third insulator 110 of a third chamber 610 can be fixed to a portion 155 of at least one of the third lateral wall 625 and the fourth lateral wall 630. A fourth insulator 110 of a fourth chamber 610 can be fixed to a portion 155 of at least one of the fourth lateral wall 630 and the fifth lateral wall 635.

The insulators 110 can be fixed to the lateral walls of the chambers 610 a distance from an end of each lateral wall forming an exposed portion 130 of the lateral walls of the chambers 610. A single cover can cover the chambers 610. The battery cell 100 can include multiple covers. The covers can cover one chamber 610 or more than one chamber 610. For example, a first cover could cover two chambers and a second cover could cover two other chambers. The cover can be fixed to the ends of the lateral walls 615-635. The cover can be fixed to the exposed portions 130 of at least one lateral wall of the chambers 610. The cover can be fixed to the exposed portions 130 of at least one of the lateral walls 615-630 via welding, laser welding, rivets, snaps, or other connectors.

FIG. 6C depicts an example prismatic battery cell 100 including multiple chambers 610 for active battery components. The battery cell 100 of FIG. 6C is shown from a perspective view. The battery housing 105 can include a front lateral wall 640 and a rear lateral wall 645. The front lateral wall 640 and the rear lateral wall 645, together with the lateral walls 615-635 can form the chambers 610. An outer shape of the battery housing 105 can be a prismatic shape. However, the battery housing 105 can be a cylindrical shape, a spherical shape, a pyramid shape, or any other form factor. The chambers 610 can be prismatic shaped. However, the chambers 610 can be any form factor, for example a cylindrical shape, a spherical shape, a pyramid shape. The outer shape of the battery housing 105 can be the same shape or a different shape than the shape of the chambers 610. Furthermore, the lateral walls 615-635, the front lateral wall 640, and the rear lateral wall 645 can be flat. However, at last one of the lateral walls 615-635, the front lateral wall 640, and the rear lateral wall 645 can be curved or rounded. The insulators 110 of the chambers 610 can be fixed to a portion 155 of at least one of the front lateral wall 640 or the rear lateral wall 645. A cover can be fixed to an exposed portion 130 of at least one of the front lateral wall 640 or the rear lateral wall 645.

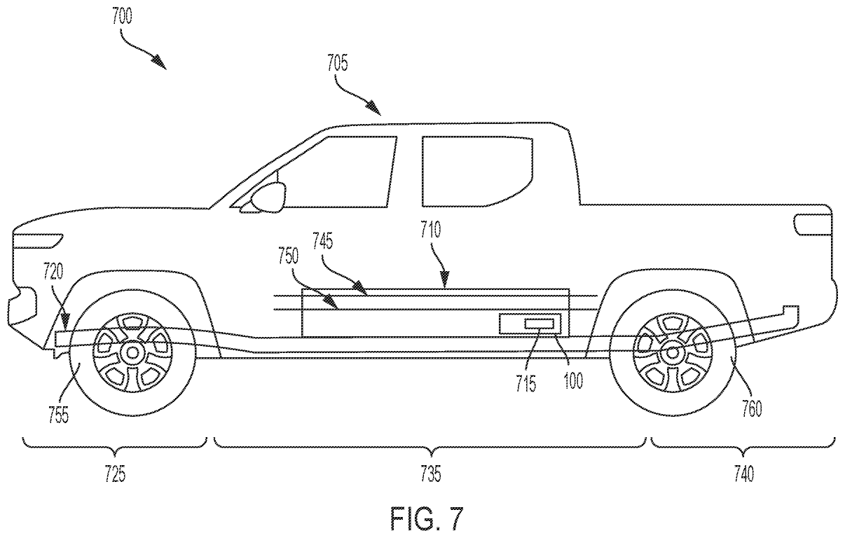

FIG. 7 depicts is an example cross-sectional view of a vehicle 705 installed with at least one battery pack 710. The vehicle 705 can be an electric vehicle. Electric vehicles 705 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 710 can be used as an energy storage system to power a building, such as a residential home or commercial building. Electric vehicles 705 can be fully electric or partially electric (e.g., plug-in hybrid) and further, electric vehicles 705 can be fully autonomous, partially autonomous, or unmanned. The vehicle 705 can be a gas or diesel powered vehicle. Electric vehicles 705 can be human operated or non-autonomous. Electric vehicles 705 such as electric trucks or automobiles can include on-board battery packs 710, battery modules 715, or battery cells 100 to power the electric vehicles. The vehicle 705 can include a chassis 720 (e.g., a frame, internal frame, or support structure). The chassis 720 can support various components of the vehicle 705. The chassis 720 can span a front portion 725 (e.g., a hood or bonnet portion), a body portion 735, and a rear portion 740 (e.g., a trunk, payload, or boot portion) of the electric vehicle 705. The battery pack 710 can be installed or placed within the vehicle 705. For example, the battery pack 710 can be installed on the chassis 720 of the vehicle 705 within one or more of the front portion 725, the body portion 735, or the rear portion 740. The battery pack 710 can include or connect with at least one busbar, e.g., a current collector element. For example, the first busbar 745 and the second busbar 750 can include electrically conductive material to connect or otherwise electrically couple the battery modules 715 or the battery cells 100 with other electrical components of the vehicle 705 to provide electrical power to various systems or components of the vehicle 705.

The vehicle 705 can include at least one front wheel 755 and at least one rear wheel 760. The vehicle 705 can include one or multiple motors. The motors can drive an axel connected to two front wheels 755 or an axel connected to two rear wheels 760. A single motor can drive an axel of the two front wheels 755. A single motor can drive an axel of the two rear wheels 760. Each wheel of the wheels 755 and 760 can be driven by an individual motor. For example, each of the four wheels 755 and 760 can be driven by one of four motors. The battery pack 710 can discharge stored energy to power the motors of the front wheels 755 and the rear wheels 760. The battery pack 710 can discharge stored energy to generate power that the motors receive. Operating the motors of the wheels 755 and 760 can cause the vehicle 705 to drive forward, reverse, or turn. A tractive component, e.g., a motor, can transports the electric vehicle 705 based on power received from the battery cells 100.

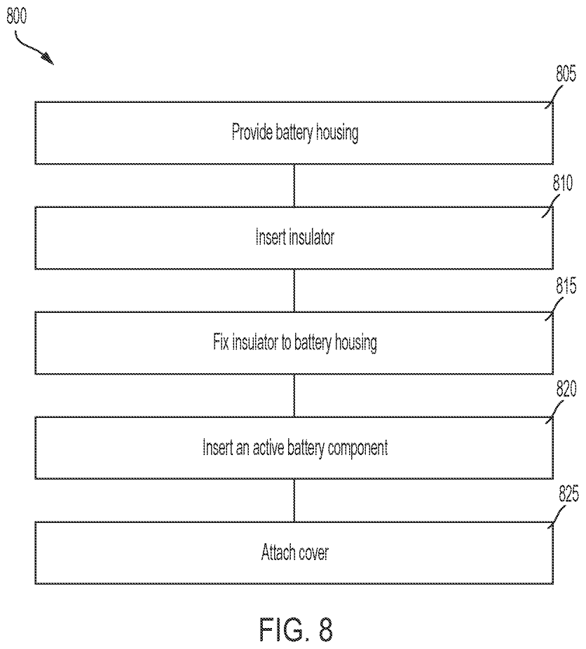

FIG. 8 depicts an example method 800 of manufacturing a battery cell including an insulator. At least one ACT of the method 800 can be performed by a manufacturing apparatus that manufactures battery cells. The apparatus that manufactures battery cells can include lifts, rollers, actuators, pistons, robotic arms, welding components or a variety of other components to manufacture a battery cell. At least one ACT of the method 800 can be performed by a manufacturing individual, e.g., a technician, a welder, or other person. The method 800 can include an ACT 805 of providing a battery housing. The method 800 can include an ACT 810 of inserting an insulator. The method 800 can include an ACT 815 of fixing the insulator to the housing. The method 800 can include an ACT 820 of inserting an active battery component. The method 800 can include an ACT of attaching a cover 215.

At ACT 805, the method 800 can include providing the battery housing 105. The battery housing 105 can be a prismatic shaped housing, a cylindrical shaped housing, a pouch shaped housing, or any other form factor battery housing. The battery housing 105 can include a first lateral wall 115 and a second lateral wall 120. The battery housing 105 can include a bottom side 125. The battery housing 105 can include a third lateral wall 410 and a fourth lateral wall 225. The lateral walls of the battery housing 105 can form a cavity. The cavity can be a prismatic shaped cavity, a cylindrical shaped cavity, a pouch shaped cavity, or any other form factor cavity.

The first lateral wall 115, the second lateral wall 120, the third lateral wall 410, and the fourth lateral wall 225 can extend up from the bottom side 125. Furthermore, an edge of the first lateral wall 115 can be fixed to an edge of the second lateral wall 120. An edge of the second lateral wall 120 can be fixed to an edge of the third lateral wall 410. An edge of the third lateral wall 410 can be fixed to an edge of the fourth lateral wall. An edge of the fourth lateral wall can be fixed to an edge of the first lateral wall 115. The lateral walls can include inner sides that define the cavity. The lateral walls can include outer sides opposite the inner sides. The first lateral wall 115, the second lateral wall 120, the third lateral wall 410, the fourth lateral wall 225, or the bottom side 125 can be electrically coupled with a terminal of the battery cell 100 or an electrode of the battery cell 100 (e.g., an anode or cathode).

At ACT 810, the method 800 can include inserting the insulator 110. The insulator 110 can be inserted into the cavity of the battery cell 100. The insulator 110 can be inserted into a cavity formed by the first lateral wall 115, the second lateral wall 120, the third lateral wall 410, the fourth lateral wall 225, and the bottom side 125. The insulator 110 can be inserted through an opening of the battery housing 105. The opening can be formed by ends of the first lateral wall 115, the second lateral wall 120, the third lateral wall 410, the fourth lateral wall 225 opposite the bottom side 125. The insulator 110 can be a pouch or bag shaped insulator. The insulator 110 can be a seamless insulator. For example, the insulator 110 can be formed from a single piece of material instead of joining together multiple pieces of material. The insulator 110 can include a form that conforms to the shape and size of the cavity of the battery housing 105. For example, if the battery housing 105 is a cylindrical shape, the insulator 110 can be a cylindrically shaped insulator. If the battery housing 105 is a prismatic shape, the insulator 110 can be a prismatic or pouch shaped insulator.

At ACT 815, the method 800 can include fixing the insulator 110 to the battery housing 105. The insulator 110 can be fixed to the battery housing 105 via an adhesive. For example, before the insulator 110 is inserted into the battery housing 105, an adhesive can be applied to the battery housing 105 or the insulator 110. For example, the adhesive can be applied to a portion 155 of an inner surface of the battery housing 105. The adhesive can be applied to a portion 155 of an outer surface of the insulator 110. The insulator 110 can be pressed against the inner surface of the battery housing 105 such that the adhesive makes contact with the outer surface of the insulator 110 and the inner surface of the battery housing 105. When the adhesive cures, the portion 155 of the insulator 110 and the portion 155 of the battery housing 105 can be fixed.

The adhesive can be applied in a pattern around the opening of the battery housing 105. The adhesive can extend across a portion, or an entirety, of the first lateral wall 115 of the battery housing 105, the second lateral wall 120 of the battery housing 105, a third lateral wall 410 of the battery housing 105, or a fourth lateral wall 225 of the battery housing 105. A portion 155 of an inner surface of the first lateral wall 115 of the battery housing 105 can be fixed to a portion 155 of an outer surface of the first lateral side 135 of the insulator 110. A portion 155 of an inner surface of the second lateral wall 120 of the battery housing 105 can be fixed to a portion 155 of an outer surface of the second lateral side 140 of the insulator 110 via the adhesive. A portion 155 of an inner surface of the third lateral wall 410 of the battery housing 105 can be fixed to a portion 155 of an outer surface of the third lateral side 205 of the insulator 110 via the adhesive. A portion 155 of an inner surface of the fourth lateral wall 225 of the battery housing 105 can be fixed to a portion 155 of an outer surface of the fourth lateral side 210 of the insulator 110 via the adhesive.

At ACT 820, the method 800 can include inserting at least one active battery component 305. The active battery components 305 can be inserted into the battery housing 105. The active battery component 305 can be inserted into insulator 110. The active battery component 305 can be at least one anode layer 320, at least one cathode layer 310, at least one separator or electrolyte layer 315, an electrolyte solution or any other component that causes the battery cell 100 to charge, discharge, or store energy. The active battery components 305 can be inserted through an opening of a cavity formed by ends of the first lateral wall 115 of the battery housing 105, the second lateral wall 120 of the battery housing 105, the third lateral wall 410 of the battery housing 105, and a fourth lateral wall 225 of the battery housing 105. The active battery components 305 can be inserted through an opening of a cavity formed by ends of the first lateral side 135 of the insulator 110, the second lateral side 140 of the insulator 110, the third lateral side 205 of the insulator 110, and a fourth lateral side 210 of the insulator 110.

At ACT 825, the method 800 can include attaching the cover 215. The cover 215 can be attached to the battery housing 105. The cover 215 can be attached over an opening of the battery housing 105 and an opening of the insulator 110. The cover 215 can be fixed to the lateral walls of the battery housing 105, for example, the first lateral wall 115, the second lateral wall 120, the third lateral wall 410, or the fourth lateral wall 225. The cover 215 can be fixed to a exposed portion 130 of the first lateral wall 115, the second lateral wall 120, the third lateral wall 410, or the fourth lateral wall 225. The exposed portion can be defined by a distance between ends of the lateral walls of the battery housing 105 and ends of the sides of the insulator 105. The cover 215 can be fixed to the exposed portion 130. For example, the cover 215 can be fixed to the exposed portion 130 via welding, laser welding, rivets, snaps, or other connectors. The cover 215 can be electrically coupled to the exposed portion 130.

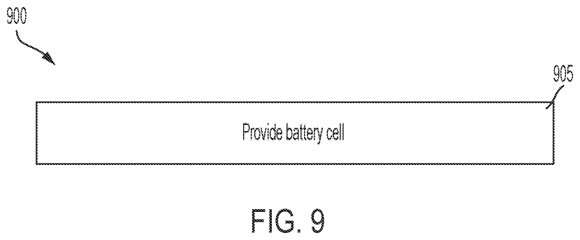

FIG. 9 depicts an example method 900 of providing a battery cell. The method 900 can include an ACT 905 of providing the battery cell 100. The battery cell 100 can include a battery housing 105. The battery cell 100 can include an insulator 105. The insulator 105 can be a seamless insulator. The insulator 105 can be a pouch or bag shaped insulator. A portion 155 of an outer surface of the insulator can be fixed to a portion 155 of an inner surface of the battery cell 100. The outer surface of the insulator 110 can be fixed to the inner surface of the battery cell 100 via an adhesive. The adhesive can be applied partially or completely around the inner surface of the battery housing 105. A portion 155 of an inner surface of the first lateral wall 115 of the battery housing 105 can be fixed to a portion 155 of an outer surface of the first lateral side 135 of the insulator 110. A portion 155 of an inner surface of the second lateral wall 120 of the battery housing 105 can be fixed to a portion 155 of an outer surface of the second lateral side 140 of the insulator 110 via the adhesive. A portion 155 of an inner surface of the third lateral wall 410 of the battery housing 105 can be fixed to a portion 155 of an outer surface of the third lateral side 205 of the insulator 110 via the adhesive. A portion 155 of an inner surface of the fourth lateral wall 225 of the battery housing 105 can be fixed to a portion 155 of an outer surface of the fourth lateral side 210 of the insulator 110 via the adhesive.

Ends of the lateral sides of the insulator 105 can be separated by a distance from ends of the lateral walls of the battery housing 105. The separation distance can define a exposed portion 130 where no adhesive or insulator is present. The cover 215 can be fixed to the lateral walls of the battery housing 105 via the exposed portion 130. For example, the exposed portion 130 can be used for welding and connecting the cover 215 to the battery housing 105.

At least one active battery component 305 can be disposed within a cavity of the battery housing 105 or the insulator 110. The insulator 110 can insulate the active battery component 305 from the battery housing 105. For example, the battery housing 105 can be electrically coupled to at least one active battery component 305, e.g., the anode layer 320 or the cathode layer 310. If the battery housing 105 is positive, the insulator 110 can prevent the cathode layer 320 from contacting and shorting with the battery housing 105. If the battery housing 105 is negative, the insulator 110 can prevent the anode layer 310 from contacting and shorting with the battery housing 105.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B.’ Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. For example, the battery cell described herein can be used in electric vehicles. However, the battery cell described herein can be used in various other electronic devices, e.g., smartphones, laptops, battery powered keys, headphones, keyboards, flashlights, or any other battery powered device. For example, the insulator described herein can be partially or fully fixed to an inner surface of a battery enclosure. One, two, three, or four lateral sides can be partially or completely fixed to an inner surface of the battery enclosure. Furthermore, a bottom of the insulator can be partially or completely fixed to an inner surface of the battery enclosure. For example, the insulator can be a seamless insulator. However, the insulator can include one, two, three, or more seams. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A device, comprising:
a battery housing comprising a first lateral wall and a second lateral wall; and
an insulator disposed within the battery housing between the battery housing and an active battery component;
a portion of the insulator fixed to an inner surface of the first lateral wall and the portion of the insulator fixed to an inner surface of the second lateral wall.

2. The device of claim 1, comprising:
the insulator, wherein an end of the insulator is fixed to the inner surface of the first lateral wall at a location a distance from an end of the first lateral wall, the distance defines an exposed portion of the first lateral wall.

3. The device of claim 1, comprising:
the insulator, wherein an end of the insulator is fixed to the inner surface of the second lateral wall at a location a distance from an end of the second lateral wall, the distance defines an exposed portion of the second lateral wall.

4. The device of claim 1, comprising:
a cover fixed and electrically coupled to an exposed portion of the first lateral wall and an exposed portion of the second lateral wall.

5. The device of claim 1, comprising:
the first lateral wall and the second lateral wall including adhesive across the inner surface of the first lateral wall and the inner surface of the second lateral wall, the adhesive fixes the portion of the insulator to the inner surface of the first lateral wall and the inner surface of the second lateral wall.

6. The device of claim 1, comprising:
the battery housing including adhesive applied across the inner surface of the first lateral wall, the inner surface of the second lateral wall, an inner surface of a third lateral wall of the battery housing, and an inner surface of a fourth lateral wall of the battery housing, the adhesive fixes the portion of the insulator to the inner surface of the first lateral wall, the inner surface of the second lateral wall, the inner surface of the third lateral wall, and the inner surface of the fourth lateral wall of the battery housing.

7. The device of claim 1, comprising:
the first lateral wall including:
a first portion including adhesive applied to the first portion; and
a second portion free of adhesive.

8. The device of claim 1, comprising:
the insulator comprising:
a bottom side;
a first side, a portion of the first side fixed to the inner surface of the first lateral wall, the first side extends from the bottom side to an opening of the insulator; and
a second side, a portion of the second side fixed to the inner surface of the second lateral wall, the second side extends from the bottom side to the opening of the insulator.

9. The device of claim 1, comprising:
the insulator comprising:
a bottom side free of adhesive;
a first side, a portion of the first side fixed to the inner surface of the first lateral wall by the adhesive; and
a second side, a portion of the second side fixed to the inner surface of the second lateral wall by the adhesive.

10. The device of claim 1, comprising:
the battery housing comprising a third lateral wall and a fourth lateral wall; and
the insulator comprising:
a first side fixed to the inner surface of the first lateral;
a second side fixed to the inner surface of the second lateral wall;
a third side fixed to an inner surface of the third lateral wall; and
a fourth side fixed to an inner surface of the fourth lateral wall.

11. The device of claim 1, wherein the insulator and the battery housing define:
an air gap between the battery housing and the insulator, the air gap provides insulation between the battery housing and the active battery component.

12. The device of claim 1, wherein the insulator is a pouch shaped insulator or a bag shaped insulator.

13. The device of claim 1, wherein the insulator is a seamless insulator.

14. The device of claim 1, wherein:
the portion of the insulator is fixed to the inner surface of the first lateral wall at a location a distance of one to two millimeters from an end of the first lateral wall; and
the portion of the insulator is fixed to the inner surface of the second lateral wall at a location a distance of one to two millimeters from an end of the second lateral wall.

15. The device of claim 1, wherein the battery housing has a first polarity; and
wherein the insulator insulates an electrode of the active battery component of a second polarity from the battery housing.

16. A method, comprising:
providing a battery housing comprising a first lateral wall and a second lateral wall;
inserting an insulator into the battery housing;
fixing a portion of the insulator to an inner surface of the first lateral wall and to an inner surface of the second lateral wall; and
inserting an active battery component into the insulator.

17. The method of claim 16, comprising:
providing a cover for the battery housing; and
fixing the cover to an exposed portion of the battery housing, wherein an end of the insulator is fixed to the inner surface of the first lateral wall at a location a distance from an end of the first lateral wall, the distance defining the exposed portion of the first lateral wall.

18. A battery cell comprising:
a battery housing comprising a first lateral wall and a second lateral wall;
an insulator disposed within the battery housing between the battery housing and an active battery component; and
a portion of the insulator fixed to an inner surface of the first lateral wall and the portion of the insulator fixed to an inner surface of the second lateral wall.

19. The battery cell of claim 18, comprising:
the insulator, wherein an end of the insulator is fixed to the inner surface of the first lateral wall at a location a distance from an end of the first lateral wall, the distance defines an exposed portion of the first lateral wall.

20. The battery cell of claim 18, wherein the insulator is a seamless insulator.
